(19) United States
(12) Patent Application Publication
(10) Pub. No.: US 2004/0055114 A1
(43) Pub. Date: Mar. 25, 2004

(54) Hinge assembly for supporting LCD display panel

(76) Inventor: Sheng-Nan Lu, Taipei Hsien (TW)

Correspondence Address: Rabin & Berdo, P.C., Suite 500, 1101 14th Street, Washington, DC, 20005, US

(21) Appl. No.: 10/246,475

(22) Filed: Sep. 19, 2002

(51) Int. Cl. E05D 11/08

(52) U.S. Cl. 16/340

(57) ABSTRACT

A hinge assembly for enabling an LCD display panel to be adjusted to a suitable viewing angle and the supporting stand to be folded up against the back of the display panel is disclosed. The stand bracket is installed on the supporting stand for locking against the middle section of a hinge shaft by locating ears. Two panel brackets are mounted on two ends at the back of the display panel locking against the hinge shaft by locating ears. The hinge shaft is fitted with hinge components from both ends, including torsion springs, guide plates, torsion springs and terminal nuts. Through the mechanical action of the torsion springs and guide plates, an LCD monitor can be adjusted to a suitable viewing angle, and the supporting stand can be fully folded against the back of the panel for storage with limited space and for economical transportation.

### BACKGROUND OF THE INVENTION

1. Field of the Invention

The present invention relates to a hinge assembly for supporting an LCD display panel, in particular to a design for hinge assembly that enables the supporting stand of the LCD monitor to be folded up against the back of the display panel for saving space in packing and storage.

2. Description of Related Arts

Liquid crystal display (LCD) screens have gradually replaced cathode ray tube (CRT) to be consumers' first choice in selecting a monitor, attracted by a number of features such as slim form, light weight, and low EMR.

Although the slim display panel does not occupy too much space on the desk top, it needs an appropriate supporting means to position the display panel at a suitable angle for best viewing effects. There are two kinds of supporting stand commonly used for flat panel displays. The first kind of supporting stand is designed to be placed at the bottom of the monitor, with a complicated mechanical structure, such that the flat display panel can be kept above the desk level. This supporting stand can provide a good support for the monitor, but its structural design is more complex and more assembling parts are required as compared with the second kind.

The second kind uses a single-shaft supporting stand, where the main shaft is joined by a hinge assembly mounted on the back of the display panel. The bottom of the support stand for the flat panel display is placed over the desk, and the supporting shaft is linked to the back of the display panel, allowing the panel inclination to be adjusted by rotating the supporting stand against the display panel, and the supporting stand can be fully retracted to recline on the back wall of the display panel.

The above mentioned design of the supporting stand is both simple and economical, requiring considerably few parts, as well as saving costs.

From the foregoing, it is clear that the hinge assembly is an important element in the display panel support. The above mentioned supporting stand relies on the hinge mechanism to link the stand bracket and the panel bracket in the display panel assembly.

According to the structure of a currently used hinge assembly for LCD monitors, the hinge assembly includes a horizontal part installed on the supporting member to be fitted against one end of a hinge shaft; the hinge shaft is fitted with components like torsion springs, coupling leaves, and cylindrical caps from both ends; the cylindrical cap is placed over the extremity of the hinge shaft; one end of the torsion spring is secured to the horizontal part, and the other end is fixed on the coupling leaf of the supporting member rotator; the two supporting member rotators are mounted onto the back of the display panel by means of a vertical leaf; and the coupling leaf has a limit slot for lodging the lateral side of the horizontal part in the limit slot thus forming the hinge assembly. The hinge assembly enables the included angle between the support stand and the display panel to be rotatably adjusted, resulting in the changing of the viewing angle of the LCD monitor.

The above mentioned design for the hinge assembly has placed the main emphasis on the support for the display panel. However, the coupling leaf on the supporting member rotator has a limit slot hindering the movement of the horizontal part on the supporting member, thereby limiting the angle of adjustment on the supporting member. Furthermore, rotation of the moving part is blocked by the limiting slot when folding up the supporting member for storage. Therefore the supporting stand cannot be completely reclined against the back of the display panel in the fold-up position, for which extra space is needed for packing the display panel and for storage, and the transportation cost is also adversely affected.

### SUMMARY OF THE INVENTION

The main object of the present invention is to provide a hinge assembly for supporting an LCD display panel that enables the supporting stand to be completely reclined against the back of the display panel in the fold-up position. The reduced form factor enables cost saving and space saving with economical packing of the product for transportation and storage.

The hinge assembly comprises a stand bracket installed on the supporting stand, two panel brackets mounted on the back of the display panel, and a hinge shaft for joining the supporting stand and the display panel.

The hinge components including a hinge shaft, torsion springs, two guide plates, and two terminal nuts are fitted from both ends onto the hinge shaft, which are assembled together through the locating ears of the stand bracket and the panel brackets for joining the supporting stand and the display panel.

Two panel brackets are mounted on two ends at the back of the display panel.

Through the action of the torsion springs and guide plate in the hinge, the supporting stand is rotated in order to adjust the included angle between the display panel and the supporting stand panel, resulting in a best viewing angle for the LCD display panel. The present invention enables the supporting stand to be folded up reclining against the back of the display panel for saving storage space and economical packing in transportation.

The features and structure of the present invention will be more clearly understood when taken in conjunction with the accompanying figures.

### BRIEF DESCRIPTION OF THE DRAWINGS

FIG. 1 is an exploded diagram of the present invention;

FIG. 2 is the plan and bottom view of the hinge assembly;

FIG. 3 is the side view of a supporting stand assembled onto an LCD display panel adjusting for different viewing angles;

FIG. 4 is the side view see-through diagram of the hinge assembly as the LCD display panel is in the standing position;

FIG. 5 is the side view see-through diagram of the hinge assembly as the LCD display panel is in the fold-up position; and

FIG. 6 is a perspective view of the supporting stand folded up against the back of an LCD display panel.

### DETAILED DESCRIPTION OF THE PREFERRED EMBODIMENT

In the following detailed description of the preferred embodiment, reference is made to the accompanying drawings, which shows specific embodiments in which the invention may be practiced. In the drawings, and like numerals describe substantially similar components throughout the several views. These embodiments are described in sufficient detail to enable those skilled in the art to practice the invention. Other embodiments may be used and structural, logical and electrical changes may be made without departing from the scope of the present invention.

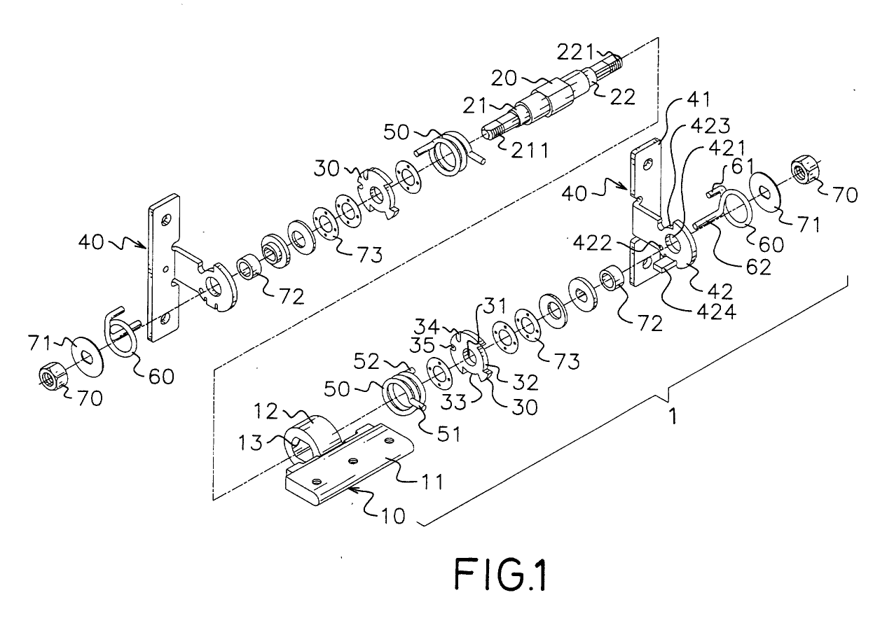

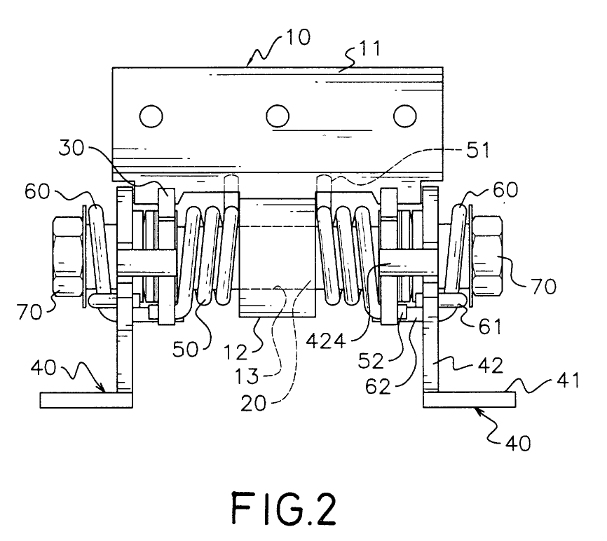

FIGS. 1 and 2 show the structure of a hinged supporting stand in accordance with the present invention, used for supporting an LCD display panel. The hinge assembly (1) comprises a stand bracket (10), two guide plates (30), two panel brackets (40), a hinge shaft (20), torsion springs (50) (60), and terminal nuts (70).

The stand bracket (10) is formed by a fixing portion (11), having multiple through holes for fitting screws and rivets, and a locating ear (12) on the lateral side having a fixing hole (121) through the center.

The hinge shaft (20) is divided into a left portion (21) and a right portion (22) both of which have threaded portions (211) (221) at the ends. The hinge is assembled by sliding the shaft (20) through the fixing hole (13) of the locating ear (12) and fixing holes (421) of horizontal ear portions (42) of the panel brackets (40).

The two guide plates (30) are installed on the left portion (21) and right portion (22) of the hinge shaft (20) respectively, wherein each guide plate (30) has a through hole (31) in the center for the hinge shaft (20) to pass through, and the outer rim of the guide plate (30) is shaped by a first limiting slot (32), a second limiting slot (33), a first locating notch (34) and a second locating notch (35).

The two panel brackets (40) are installed on two ends at the back of the display panel (80), wherein each is formed by a vertical portion (41) and the horizontal ear portion (42). The horizontal ear portions (42) are locked in by the left portion (21) and the right portion (22) of the hinge shaft (20) after finishing the assembly, and positioned on the outside of the two guide plates (30). The horizontal ear portion (42) arises from the middle section of the vertical portion (41). The vertical portion (41) has holes in upper and lower parts thereof for fitting screws or rivets. The horizontal ear portions (42) of the two panel brackets (40) each have fixing holes (421) (422) used for the hinge shaft (20) to run through. The horizontal ear portion (42) has a notch (423) on an upper edge thereof, and a nose (424) perpendicularly extending from the bottom of the horizontal ear portion (42) for fitting against the second limiting slot (33) of the adjacent guide plate (30).

The two inner torsion springs (50) are respectively installed on the ends of the stand bracket (10) and adjacent to the guide plate (30) on each side, allowing the hinge shaft (20) to pass through the center of the springs (50). Each inner torsion spring (50) is secured to the fixing portion (11) of the stand bracket and the second locating notch (35) of the guide plate (30) respectively through a first end (51) and a second end (52) of each spring (50).

The two outer torsion springs (60) are respectively attached onto the left portion (21) and right portion (22) of the hinge shaft (20), and arranged on the outside of the horizontal ear portions (42) of the panel brackets (40). Each outer torsion spring (60) is secured to the fixing hole (422) of the horizontal ear portion (42) and the notch (423) of the horizontal ear portion (42) and the first locating notch (34) of the guide plate (30) respectively through a first end (61) and a second end (62) of each spring (60).

The two terminal nuts (70) are fitted onto the threaded ends (211) (221) of the left portion (21) and right portion (22) together with a friction washer (71).

The through holes (421) of the two panel brackets (40) are fitted with a sleeve (72) for the hinge shaft (20) to run through the center portion, having friction washers (73) placed between the horizontal ear portion (42) and the guide plate (30).

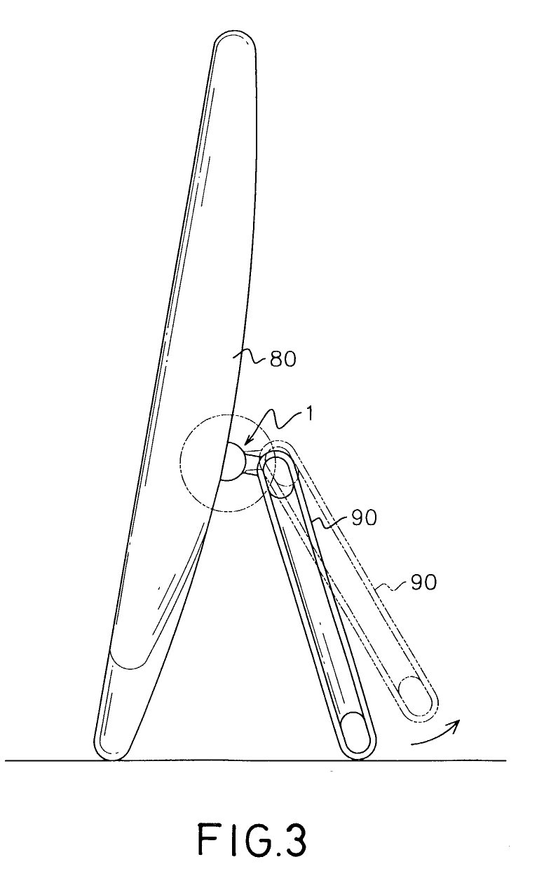

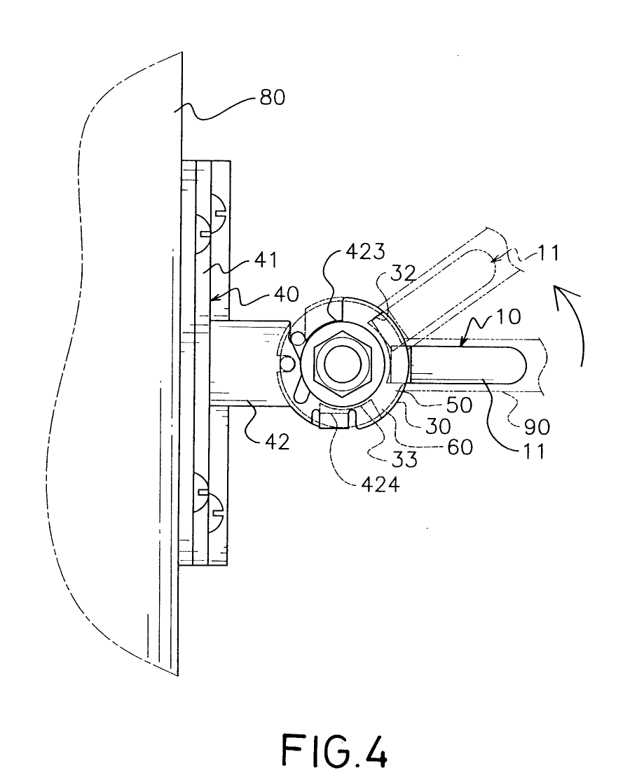

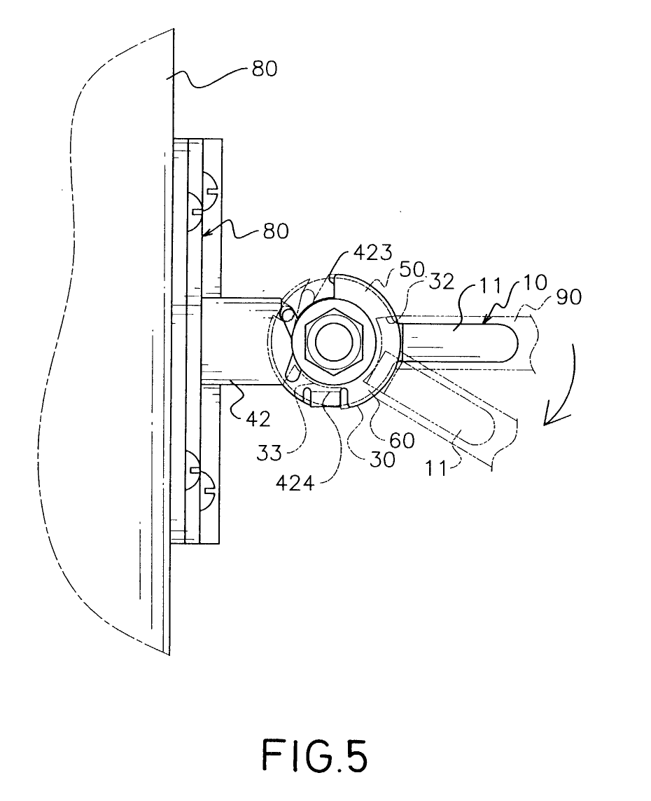

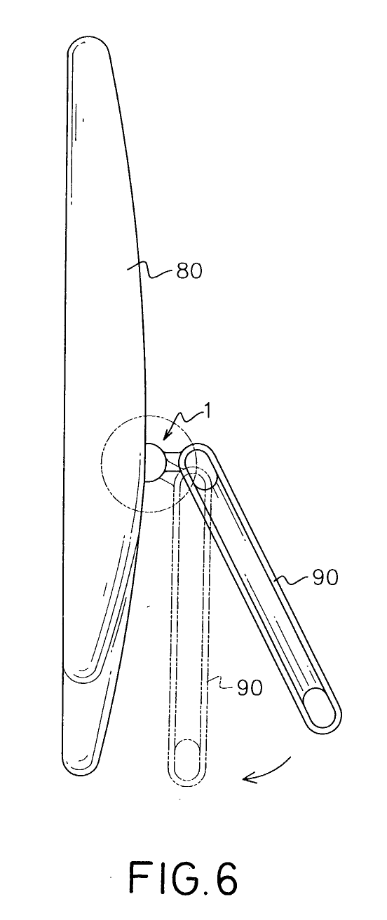

With reference to FIGS. 3 and 4, during actual operation of the hinge assembly (1), the vertical portions (41) of the two panel brackets (40) are pressed against the back wall of the LCD display panel (80), which are fixed thereon by means of screws or rivets. The fixing portion (11) of the stand bracket (10) is fixed on the supporting stand (90) by means of screws or rivets. Under this mechanical structure, the tension from the inner torsion springs (50) on both ends during rotation motion enables the included angle between the LCD display panel (80) and the supporting stand to be changed to suit the desired inclination of the display panel. In addition, the tension on the torsion spring (50) can be used for folding up the supporting stand against the back wall of the display panel as shown in FIGS. 5 and 6, such that the LCD display panel (80) can be folded up reclining against the back of the LCD display panel (80). When the outer torsion springs (60) are restored to their original form, the supporting stand will be fully stretched to the normal position.

Comparing the features of the previously mentioned hinge assembly and the present invention, it is clear that the hinged supporting stand under the present invention allows an LCD display panel to be stored away or packed with less space, which means cost saving in transportation and space saving for storage.

The display panel mounted with the supporting stand of the present invention can be easily adjusted to the desired inclination angle within the predetermined range of motion. By the action of the outer torsion springs and guide plate, the supporting stand can be folded up against the back of the display panel to reduce the form factor for economical transportation and easy storage. When the display panel is taken out from a packing box, the tension of the outer torsion spring will quickly restore the supporting stand to its original form whereby the LCD monitor will be set up with the best viewing angle.

The foregoing description of the preferred embodiments of the present invention is intended to be illustrative only and, under no circumstances, should the scope of the present invention be so restricted.

What is claimed is:

1. A hinge assembly for supporting an LCD display panel, to be installed on the back of the display panel joining the supporting stands for easy adjustment of a viewing angle, comprises:
a stand bracket formed by a fixing portion, having multiple holes defined through the fixing portion for fitting screws and rivets, and a locating ear on a lateral side having a fixing hole through the center of the locating ear;
a hinge shaft divided into a left portion and a right portion, both of left and right portions having a threaded end;
two guide plates installed on the left portion and right portion of the hinge shaft respectively, wherein each guide plate has a through hole in the center for the hinge shaft to pass through, and an outer rim of the guide plate is shaped by a first limiting slot, a second limiting slot, a first locating notch, and a second locating notch;
two panel brackets installed respectively on two ends at the back of the display panel, wherein each panel bracket is formed by a vertical portion and a horizontal ear portion portion, such that the horizontal ear portions are locked respectively in by the left portion and the right portion of the hinge shaft and positioned on an outside of the two guide plates; the horizontal ear portion arises from a middle section of the vertical portion, which has holes on the upper and lower parts for fitting screws or rivets; the horizontal ear portions of the two panel brackets each having fixing holes for the hinge shaft to run through; each horizontal ear portion has a notch on an upper part thereof and a nose extending from the bottom of the horizontal ear portion perpendicularly for fitting against the second limiting slot of the adjacent guide plate;
two inner torsion springs respectively installed on two ends of the stand bracket adjacent to the guide plate on each side, allowing the hinge shaft to pass through the center of the inner torsion springs, wherein a first end of each inner torsion spring is secured to the fixing portion of the stand bracket and a second end is secured to the second locating notch of the guide plate;
two outer torsion springs respectively attached onto the left portion and right portion of the hinge shaft, outside of the horizontal ear portions of the panel brackets, wherein a first end of each outer torsion spring is secured to the fixing hole of the horizontal ear portion and a second end is secured to the notch of the horizontal ear portion and the first locating notch of the guide plate;
two terminal nuts respectively fitted onto the threaded ends of the left portion and right portion together with a friction washer; such that the hinge is assembled by sliding the shaft portion through the locating ear of the stand bracket and the horizontal ear portions of the panel brackets, thus joining the display panel and the supporting stand together to form the hinge assembly for an LCD monitor.

2. The hinge assembly for supporting the LCD display panel as claimed in claim 1, wherein the two panel brackets each have a sleeve mounted on the fixing hole of the horizontal ear portion for fitting the hinge shaft.

3. The hinge assembly for supporting the LCD display panel as claimed in claim 1, wherein the two panel brackets each have a sleeve mounted on the fixing hole of the horizontal ear portion for fitting the hinge shaft.

4. The hinge assembly for supporting the LCD display panel as claimed in claim 2, wherein the hinge shaft has friction washers fitted in between the horizontal ear portion and the guide plate.
